(19) United States
(12) Patent Application Publication
(10) Pub. No.: US 2006/0074721 A1
(43) Pub. Date: Apr. 6, 2006

(54) System and method for patient directed digital medical image transmittal device

(76) Inventors: Hugh V. Cotthingham, Caldwell, NJ (US); Edith Pargh, Merrick, NY (US); Michael Berneis, New York, NY (US)

Correspondence Address: STROOCK & STROOCK & LAVAN LLP, 180 MAIDEN LANE, NEW YORK, NY, 10038, US

(21) Appl. No.: 11/232,656

(22) Filed: Sep. 22, 2005

Related U.S. Application Data
(60) Provisional application No. 60/612,760, filed on Sep. 24, 2004.

(51) Int. Cl. G06F 19/00

(52) U.S. Cl. 705/3

(57) ABSTRACT

The invention generally relates to a system and method for a digital medical image transmittal service that allows a patient, at the time of a medical imaging procedure, to choose to have a digital copy of their medical image acquired by the system (service). The system utilizes a patient account number with dual passwords for isolation of account information from the medical images. Subsequently, when a doctor requests the patient to provide their medical image or images, the patient provides the doctor with their account and password information using “out-of-band” communication which ensures patient privacy and control. This system and method are the functional equivalent of the patient bringing a film-based copy of their medical image to the doctor's office and handing the film to the doctor when asked for it. In effect, instead of handing the doctor a film the patient is handing the doctor a password that allows the image to be transmitted to the doctor's computer.

### BACKGROUND

The most current data from the American College of Radiology estimates that over 470 million diagnostic imaging procedures are performed annually in the United States. Diagnostic imaging procedures include magnetic resonance (MR), computed tomography (CT) positron emission tomography (PET), nuclear medicine, ultrasound, mammography, Dual-Energy X-Ray Absorptiometry (DEXA), general radiography (X-ray) and fluoroscopy. These imaging procedures are performed on both an in-patient and out-patient basis in hospitals and in free standing diagnostic imaging centers (DICs).

Historically diagnostic imaging started with film based (X-ray). Continuing to the present, film based (X-ray) accounts for the majority of the diagnostic imaging procedures. More recently the medical profession and healthcare industry have developed advanced imaging modalities such as (MR), (CT), (PET) which are not film based but rather generate digital data as the form of output. To accommodate the prevalence of film in the healthcare industry these digital representations were converted back to film for diagnosis by the radiologist.

The introduction of these digital medical image sources and the use of computers to process the images, caused the American College of Radiology (ACR) and the National Electrical Manufacturers Association (NEMA) to form what has become known as the Digital Imaging and Communications in Medicine (DICOM) standard. DICOM is used by virtually every medical profession that utilizes images within the healthcare industry. The emergence of DICOM was also instrumental in facilitating the development of picture archiving and communication systems (PACS).

Today approximately a third of all diagnostic imaging procedures are digital and the trend indicates that the conversion from film to 100% digital is inevitable. Many of these digital images are routinely moved by online data methods between hospitals or imaging centers and their referring physicians.

While the patient has been the beneficiary of this digital development on one level on another level they have been totally left out. These systems have been created by institutions for the express benefit of the institutions and the professionals that serve them.

There is often no way for a patient to have any control over their own medical images. Patients are relegated to having to appear in-person at the hospital or imaging center where they had their imaging procedure. Often they have to acquire and pay for duplicates generated on film of their digital data to be able to transport them to another doctor or institution. The process is expensive, time consuming, sometimes embarrassing, and generally stressful for the patient.

Very recently the Health Insurance Portability and Accountability Act (HIPAA) has been passed with the intent of preventing people from losing their health insurance when they changed employers. The unintended consequence is a fear of lawsuit by all healthcare institutions and physicians which has resulted in a proliferation of legal paperwork, which the patient is required to execute before any medical image is released to them, making it dramatically more difficult for a patient to get their medical images.

### BRIEF SUMMARY OF THE INVENTION

The invention generally relates to a system and method for a service to allow a patient, at the time of an imaging procedure, to choose to have a digital copy of their digital medical image acquired by the system (service). At this time of image acquisition the patient is given a paper printout which includes an account number, an account password, an image password and the service website address. A feature of this system (service) is dual passwords. The image password only provides access to images, not to patient account information (credit card numbers, etc.).

Subsequently, when a doctor requests the patient to provide their digital medical image or images, for example in the instance when the patient has gone to another doctor for a second opinion, and if the patient wants that doctor to have their medical image or images, then the patient provides to that doctor their account number, their image password and the service website address. The patient may provide the doctor with the account number, image password and service website address by telephoning the doctor's office, faxing the doctor's office, mailing the doctor's office, or verbally at the time of the office visit. These methods of providing the account and password information are “out-of-band” in that the patient does not communicate this information through the system, but rather must go outside of the system to communicate the account and password. The patient must communicate directly with the doctor which the patient desires to receive the patient's medical image.

The doctor enters the patient's account number and the patient's image password into the web form on the webpage of the system (service) and the patient's image or images are transmitted to only that particular computer (the computer that the doctor is using) for the doctor's use.

This system and method only supports transmission of digital medical images directed by the patient through the patient's out-of-band communication of the necessary account and password information. It does not support transmission of images at the request of the doctor where the doctor has not been given the patient's account and image password which again can only come from the patient. Further, it does not support sending the patient's medical image to any computer other than the specific individual computer in which the patient's account and password information was actually entered. The patient, for instance, can't direct their digital medical images to be sent anywhere by entering their account and password information on a computer that they are using.

This system and method are the functional equivalent of the patient bringing a film-based copy of their medical image to the doctor's office and handing the film to the doctor when asked for it. In effect, instead of handing the doctor a film the patient is handing the doctor a password which caused the image to be transmitted to the doctor's computer.

The system is comprised of various networking and computer elements including, DICOM gateways which are connected either directly or via a LAN network to medical imaging modalities, such as MR, CT, PET etc. and is further comprised of hardware and software which provides web services; web servers; network attached storage and storage database servers; paper printers; web enabled and network connected PCs which are connected to either or both LAN and WAN networks; firewalls and other various network equipment (hubs, switches, etc.).

It is an object of this invention to provide a patient directed digital medical image transmittal service.

It a further object to provide a patient directed digital medical image transmittal service which is an online service utilizing the Internet.

It is another object to provide a digital medical image transmittal service which does not require the use of a computer by the patient to effect the transmission of their digital medical images to the doctor of their choice.

It is still a further object to provide a digital medical image transmittal service which utilizes out-of-band communication, of account and password information, from the patient to the doctor receiving the patient's digital medical images.

It is yet another object to provide a digital medical image transmittal service which is designed so that only the patient can effect the transmission of the patient's digital medical images to the doctor of their choice.

It is yet a further object to provide a digital medical image transmittal service which uses a two password system to ensure isolation of patient account information.

### BRIEF DESCRIPTION OF THE DRAWINGS

FIG. 1 is a diagram depicting the system elements and the method involved in the transmission of a medical image to a doctor's computer as directed by a patient.

FIG. 2 is a diagram depicting the system elements and the method involved in the acquisition of a patient's digital medical image by the system.

FIG. 3 is an example of the paper printout that the patient receives providing account and password information and instructions for the doctor.

### DETAILED DESCRIPTION OF THE INVENTION

The system and method generally have two main phases. The first is acquisition of the digital medical image by the system. The second is the transmission of the digital medical image from the system to the doctor as enabled by the patient.

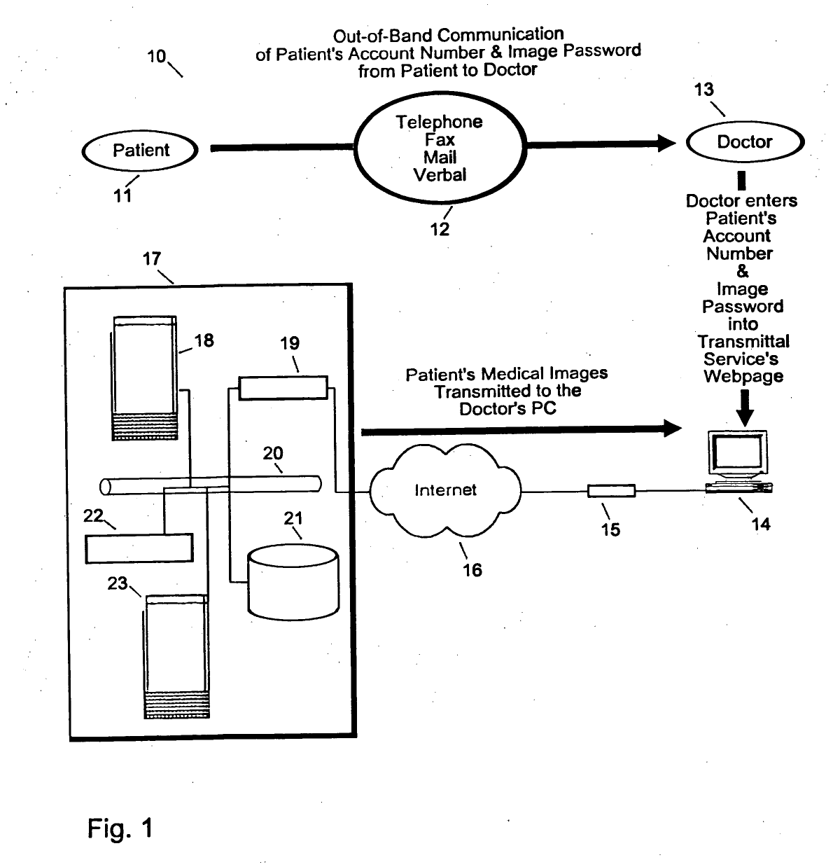

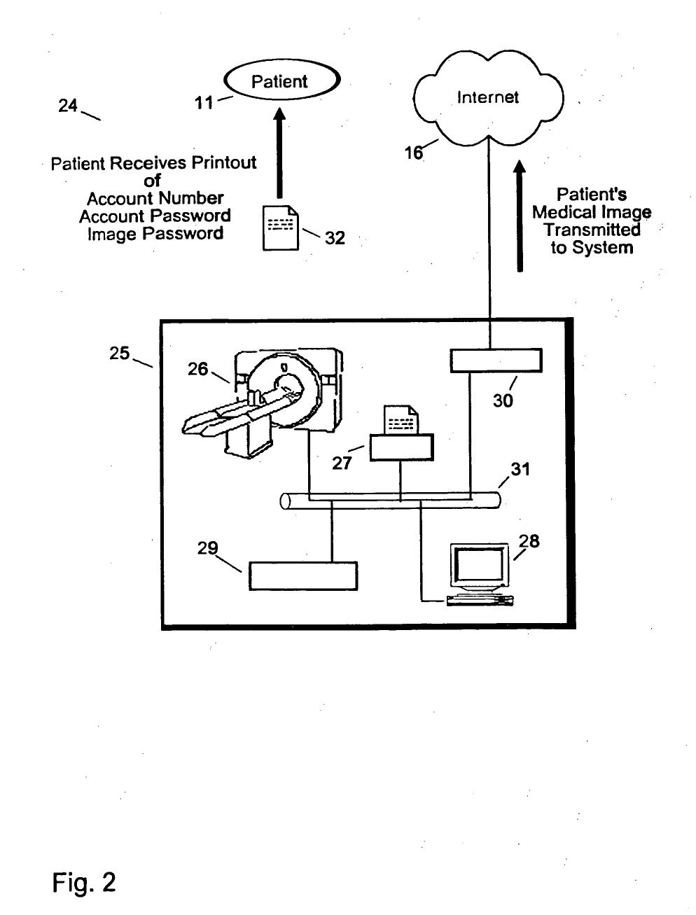

Referring to FIG. 2, the acquisition phase of the system 24 is generally depicted. A diagnostic imaging center (DIC) 25 contains an imaging modality 26 (MR, CT, PET etc.) connected to ethernet LAN 31. After the patient has undergone a diagnostic imaging procedure on imaging modality 26 the digital medical image is detected by DICOM gateway 29. The patient's digital medial image may be transmitted immediately or temporally buffered and transmitted at a later time through ethernet LAN 31 and through firewall 30 to WAN (Internet) 16 and (referring to FIG. 1) subsequently through firewall 19 and ethernet LAN 20 to DICOM gateway 22, and subsequently to Network Attached Storage (NAS) 21 as controlled by Database server 23 and Web server 18.

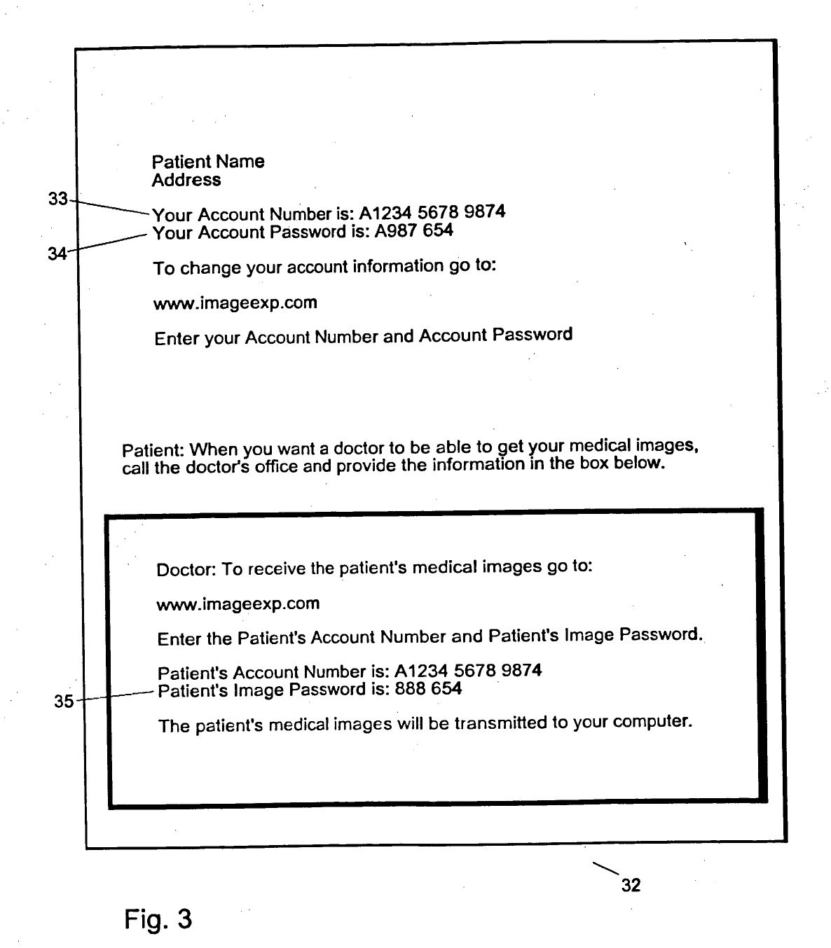

PC 28 (FIG. 2) connected to ethernet LAN 31 and further connected through firewall 30 to the WAN (Internet) 16 is operated by the DIC 25 personnel. DIC 25 personnel enter the necessary patient information, such as name and address etc., into a web form on the service's webpage. Web server 18 (FIG. 1) connected via ethernet LAN 20 and further through firewall 19 to the WAN (Internet) 16 receives the entered patient information from PC 28 and generates the patient account number 33 (FIG. 3), account password 34, and image password 35 which are stored in NAS 21 and which are transmitted via ethernet LAN 20 and firewall 19 to PC 28 via WAN (Internet) 16 and further through firewall 30. PC 28, DICOM gateways 22 and 29 (FIG. 1), Web server 18, Database server 23 and NAS 21 cooperate to link patient account information to patient medical images through metadata associated with the DICOM header of the medical image file. The patient account number 33, account password 34 and image password 35 are printed by printer 27 (FIG. 2). Printout 32 (FIG. 3) is given to the patient 11 (FIG. 2).

Referring to FIG. 1 the transmission phase of the system 10 is generally depicted. A patient 11 who desires to have their digital medical image, which is stored in NAS 21 of the system, transmitted to a particular doctor 13, communicates their account number 33 and image password 35 (FIG. 3) to the doctor 13 using any of several out-of-band communication methods such as telephone, fax, mail (including e-mail), or verbal. The doctor 13, after receiving the out-of-band communication from the patient 11 of the patient's account number 33 and image password 35, enters the account number 33 and image password 35 into the service's web form which is displayed on the doctor's computer 14. The account number 33 and image password 35 are transmitted via modem 15 or other connection to the WAN (Internet) 16 thorough firewall 19 and ethernet LAN 20 where Web server 18, Database server 23 and NAS 21 cooperate to transmit the patient's digital medical image or images through firewall 19 and WAN (Internet) 16 and further through modem 15 or other connecting means to doctor's PC 14.

We claim:

1. A system for the acquisition and subsequent transmittal of a patient's medical images via the Internet to a doctor, as directed by a patient using out-of-band communication and comprising in combination for image acquisition, an imaging modality or modalities, a first PC or first PCs for patient data entry, a first DICOM gateway or DICOM gateways, a printer, and a first Ethernet network and a first firewall, connected to the Internet; and, for image download, Web server or servers, Database server or servers, NAS, a second DICOM gateway or DICOM gateways and a second PC or PCs, for receiving a patient's medical image and an account number and password or passwords.

2. A system as claimed in claim 1 where there are two passwords, an account password which permits access to account information and an image password which permits access to images.

3. A system as claimed in claim 1 where out-of-band communication of passwords includes using the telephone, using a FAX machine, using mail including e-mail, or verbally from patient to doctor or doctor's office personnel.

4. A system as claimed in claim 1 where a printer is used to produce a hard copy of the patient's account number, account password, and image password.

5. A system as claimed in claim 1 where imaging modality includes magnetic resonance (MR), computed tomography (CT), positron emission tomography (PET), digital radiography (X-ray), digital Mammography, Ultrasound, Nuclear Medicine and Dual-Energy X-Ray Absorptiometry (DEXA).

6. A method for the acquisition and subsequent transmittal of a patient's medical images via the Internet to a doctor, as directed by a patient using out-of-band communication, including the steps of:
a. Registering a patient by collecting the information necessary to establish a patient account and;
b. Detecting the patient's medical image on an imaging modality or imaging network and;
c. Transmitting the patient's medical image via the Internet to the system's storage and;
d. Linking the patient account information to the patient medical image and;
e. Receiving the patient's account number and image password from a web form displayed on a computer connected to the Internet and;
f. Downloading the patient's medical image to the computer that provided the web form with the patient's account number and image password.

7. A method as claimed in claim 6 where step (a) may occur either before or after the patient is imaged.

8. A method as claimed in claim 6 where step (a) includes generating an account number.

9. A method as claimed in claim 6 where step (a) includes generating at least one password.

10. A method as claimed in claim 6 where step (a) includes generating more than one password.

11. A method as claimed in claim 6 where out-of-band communication includes using the telephone; using a FAX machine; using mail including e-mail; using verbal face to face communication.

12. A method as claimed in claim 6 where step (c) utilizes http protocol.

13. A method as claimed in claim 6 where step (f) utilizes ftp or http protocols.

14. A method as claimed in claim 10 where an account password and one image password is generated.

15. A method as claimed in claim 10 where multiple image passwords are generated.

16. A method as claimed in claim 15 where each password can only be used once.

17. A method as claimed in claim 6 where step (d) includes linking the patient's account information to the patient's medical image by processing the metadata associated with the DICOM header of the patient's medical image.
